(19) United States
(12) Patent Application Publication
(10) Pub. No.: US 2023/0401282 A1
(43) Pub. Date: Dec. 14, 2023

(54) COMPUTING INVERSE TEMPERATURE UPPER AND LOWER BOUNDS

(71) Applicant: Microsoft Technology Licensing, LLC, Redmond, WA (US)

(72) Inventor: Haohai YU, Redmond, WA (US)

(73) Assignee: Microsoft Technology Licensing, LLC, Redmond, WA (US)

(21) Appl. No.: 17/806,440

(22) Filed: Jun. 10, 2022

(51) Int. Cl. G06F 17/18

(52) U.S. Cl. CPC G06F 17/18

(57) ABSTRACT

A computing device including a processor configured to receive an energy function of a combinatorial optimization problem. The processor may be further configured to compute an inverse temperature lower bound, which may include estimating a maximum change in the energy function between successive timesteps. The processor may be further configured to compute an inverse temperature upper bound, which may include estimating a minimum change in the energy function between successive timesteps. The processor may be further configured to compute the solution to the combinatorial optimization problem at least in part by executing a Markov chain Monte Carlo (MCMC) algorithm over the plurality of timesteps. An inverse temperature of the MCMC algorithm may be set to the inverse temperature lower bound during an initial timestep and may be set to the inverse temperature upper bound during a final timestep. The processor may be further configured to output the solution.

### BACKGROUND

Stochastic algorithms are frequently used to estimate solutions to problems for which computing exact solutions would have high computational complexity. For example, stochastic algorithms may be used to estimate solutions to NP-complete problems such as the bin packing problem, the Boolean satisfiability problem, and the set cover problem. One type of stochastic algorithm that has achieved widespread use is the Monte Carlo algorithm, in which a distribution of outcomes of a process is sampled and one or more statistical properties of the distribution are estimated from the sample. The present disclosure relates generally to Monte Carlo approaches for evaluating combinatorial optimization problems, as discussed below.

### SUMMARY

According to one aspect of the present disclosure, a computing device is provided, including a processor configured to receive an energy function of a combinatorial optimization problem to which a solution is configured to be estimated over a plurality of timesteps. The processor may be further configured to compute an inverse temperature lower bound for the combinatorial optimization problem. Computing the inverse temperature lower bound may include estimating a maximum change in the energy function between successive timesteps of the plurality of timesteps. The processor may be further configured to compute an inverse temperature upper bound for the combinatorial optimization problem. Computing the inverse temperature upper bound may include estimating a minimum change in the energy function between successive timesteps of the plurality of timesteps. The processor may be further configured to compute the solution to the combinatorial optimization problem at least in part by executing a Markov chain Monte Carlo (MCMC) algorithm over the plurality of timesteps. An inverse temperature of the MCMC algorithm may be set to the inverse temperature lower bound during an initial timestep of the plurality of timesteps. The inverse temperature of the MCMC algorithm may be set to the inverse temperature upper bound during a final timestep of the plurality of timesteps. The processor may be further configured to output the solution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing device including a processor configured to compute a solution to a combinatorial optimization problem, according to one example embodiment.

FIG. 2 schematically shows a Markov chain Monte Carlo (MCMC) algorithm configured to be executed at the processor over a plurality of timesteps, according to the example of FIG. 1.

FIG. 3A schematically shows an example maximum energy change estimation algorithm, according to the example of FIG. 1.

FIG. 3B schematically shows a minimum energy change estimation algorithm in an example in which the combinatorial optimization problem is an Ising problem, according to the example of FIG. 1.

FIG. 3C schematically shows a minimum energy change estimation algorithm in an example in which the combinatorial optimization problem is a polynomial unconstrained binary optimization (PUBO) problem, according to the example of FIG. 1.

FIG. 4A shows a graphical user interface (GUI) configured to be displayed at a display device, according to the example of FIG. 1.

FIG. 4B shows a server computing device that is configured to communicate with a client computing device when the solution is configured to be output for display at the GUI, according to the example of FIG. 4A.

FIG. 5A shows a flowchart of a method for use with a computing device to compute an solution to a combinatorial optimization problem, according to the example of FIG. 1.

FIG. 5B shows additional steps of the method of FIG. 5A that may be performed in some examples when computing a maximum change in an energy function and a minimum change in the energy function.

FIG. 5C shows additional steps of the method of FIG. 5A that may be performed in some examples when estimating the minimum change in the energy function.

FIG. 6 shows a schematic view of an example computing environment in which the computing device of FIG. 1 may be instantiated.

### DETAILED DESCRIPTION

Combinatorial optimization problems are problems in which a maximum or minimum is computed for a scalar-valued index function of a plurality of discrete variables. In quantum inspired optimization algorithms, the scalar-valued index function is often referred to as an energy function. One common type of combinatorial optimization problem is a polynomial unconstrained binary optimization (PUBO) problem, in which the variables of the energy function have values included in the set {0,1}. Another common type of combinatorial optimization problem is an Ising problem, in which the variables of the energy function have values included in the set {−1,1}. The set of N variables of the combinatorial optimization problem may be indicated as V={X₁, . . . , X_{N}}.

The energy function of the combinatorial optimization problem may be expressed as E=ΣjTⱼ, where the terms Tⱼ of the energy function are given by

$${T}_{j} = {ω}_{j} {X}_{{i}_{1}} … {X}_{{i}_{{t}_{j}}} .$$

The terms may each have respective weights ωⱼ ∈ [symbol] and may be functions of respective subsets of the set of variables V. The number of variables included in a term Tⱼ is referred to as the degree of the term and is indicated as tⱼ.

The following additional definitions related to the combinatorial optimization problem are provided:

Define T (Xᵢ)={Tⱼ|Xᵢ∈Tⱼ} as the set of terms that include the variable Xᵢ.

Define Tⱼ[Xᵢ=ν] as a term generated from Tⱼ by setting Xᵢ to the value ν.

Define T(Xᵢ=ν)={Tⱼ [Xᵢ=ν]Tⱼ∈T(Xᵢ)} as the set of terms generated by setting Xᵢ to the value ν.

Define E_{T(X}_{ᵢ}₎=Σ_{T}_{ⱼ}_{∈T(X}_{ᵢ}₎Tⱼ as the total energy of all the terms that include the variable Xᵢ.

Define E_{T(X}_{ᵢ}_{=ν)}=Σ_{T}_{ⱼ}_{∈T(X}_{ᵢ}₎Tⱼ[Xᵢ=ν] as the total energy of all terms generated from T(Xᵢ) when Xᵢ is set to the value ν.

An example combinatorial optimization problem is provided below. In this example, the energy function E is given by:

E=0.5X₁X₂+(−7)X₁X₃8X₁X₂X₃

In this example combinatorial optimization problem, V={X₁, X₂, X₃} and the terms of E are 0.5X₁X₂, (−7)X₁X₃, and 8X₁X₂ X₃. In addition, T(X₂)={0.5X₁X₂, 8X₁X₂ X₃}. If the example combinatorial optimization problem is an Ising problem, then T(X₂=−1)={−0.5X₁, −8X₁X₃} and E_{T(X}_{₂}₌₋₁₎=−−0.5X₁+(−8)X₁X₃. If the example combinatorial optimization problem is a PUBO problem, then T(X₂=1)={0.5X₁, 8X₁X₂} and E_{T(X}_{₂}₌₁₎=0.5X₁+8X₁X₂.

Solutions to combinatorial optimization problems may be estimated via Markov chain Monte Carlo (MCMC) algorithms. In an MCMC algorithm, a plurality of timesteps are performed. During each timestep, the value of a variable of the energy function is flipped, and the change in the value of the energy function ΔE from flipping the value of the variable is computed. The change in the value of the energy function ΔE may be used to determine whether the change to the value of the variable is accepted or reverted.

In one example, when the combinatorial optimization problem is a minimization problem, the flip to the value of the variable may be accepted when ΔE<0. When ΔE>0, the flip to the value of the variable may be accepted with a probability

$${e}^{\frac{- Δ E}{T}} .$$

In this example expression for the acceptance probability, T ∈ [symbol] is a temperature that controls the extent to which the MCMC algorithm tends to explore higher-energy regions of the energy function E. Thus, when T is large, the sampling process is more similar to a random walk, and when T is small, the sampling process is more similar to a greedy search. The MCMC solver may be configured to reduce the value of T over the course of executing the MCMC algorithm, such that variable value updates that move the value of the energy function away from local minima become less probable later in the execution of the MCMC algorithm.

The inverse temperature parameter

$$β = \frac{1}{T}$$

is frequently used instead of T in combinatorial optimization problems to control the behavior of the MCMC algorithm. The value of β typically changes over the course of executing the MCMC algorithm. For different combinatorial optimization problems, different starting points, endpoints, and rates of change in β may allow for rapid convergence to an accurate solution. Thus, the user of an MCMC solver may have to select values of β suitable to a specific combinatorial optimization problem in order to efficiently and accurately obtain a solution to that combinatorial optimization problem.

In existing MCMC solvers, starting inverse temperature values βₛₜₐᵣₜ and ending inverse temperature values β_{end} are frequently requested as user inputs. However, simple inspection of the energy function typically provides the user with little useful information regarding how different values of β are likely to affect the performance of the MCMC solver. Accordingly, users of existing MCMC solvers typically obtain the starting inverse temperature values βₛₜₐᵣₜ start and ending inverse temperature values β_{end} by sampling multiple pairs of starting and ending values of β. Users run the MCMC solver with the sampled values of βₛₜₐᵣₜ and β_{end} for a reduced number of timesteps, then select values of βₛₜₐᵣₜ and β_{end} from among the sampled values and run the MCMC solver with those selected values for the full number of timesteps.

The existing approach for selecting values of βₛₜₐᵣₜ and β_{end} discussed above may be time-consuming for the user. The above approach may also result in selection of inefficient values of βₛₜₐᵣₜ and β_{end} when the user does not sample over sufficiently large ranges of values. In addition, to select values of βₛₜₐᵣₜ and β_{end} that allow the Monte Carlo search to be performed efficiently, the MCMC solver may have to perform large amounts of computation in examples in which the number of variables is large or in which the energy function is computationally expensive to evaluate. Manual selection of βₛₜₐᵣₜ β_{end} and may therefore be ill-suited to many combinatorial optimization problems.

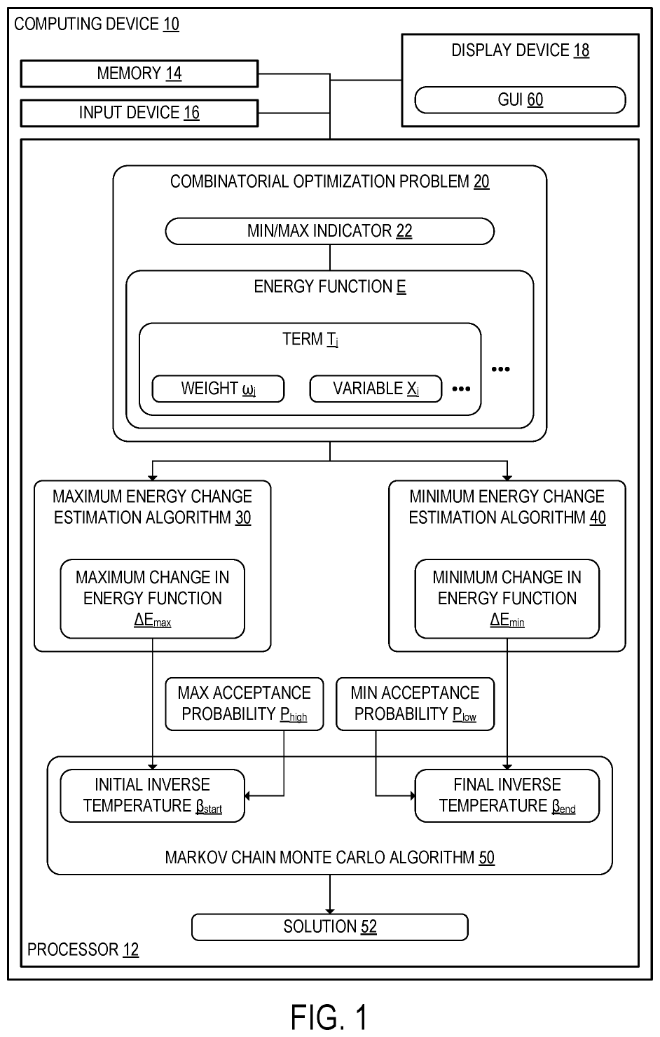

In order to address the above challenges, a computing device 10 is provided, as shown in the example of FIG. 1. The computing device 10 may include a processor 12 configured to execute instructions to perform computing processes. For example, the processor 12 may include one or more central processing units (CPUs), graphical processing units (GPUs), field-programmable gate arrays (FPGAs), specialized hardware accelerators, and/or other types of processing devices. The computing device 10 may further include memory 14 that is communicatively coupled to the processor 12. The memory 14 may, for example, include one or more volatile memory devices and/or one or more non-volatile memory devices.

Other components, such as user input devices 16 and/or user output devices, may also be included in the computing device 10. The one or more input devices 16 may, for example, include a keyboard, a mouse, a touchscreen, a microphone, an accelerometer, an optical sensor, and/or other types of input devices. The one or more output devices may include a display device 18 configured to display a graphical user interface (GUI) 60. At the GUI 60, the user may view outputs of computing processes executed at the processor 12. The user may also provide user input to the processor 12 by interacting with the GUI 60 via the one or more input devices 16. One or more other types of output devices, such as a speaker, may additionally or alternatively be included in the computing device 10.

The computing device 10 may be instantiated in a single physical computing device or in a plurality of communicatively coupled physical computing devices. For example, the computing device 10 may be provided as a physical or virtual server computing device located at a data center. In examples in which the computing device 10 is a virtual server computing device, the functionality of the processor 12 and/or the memory 14 may be distributed between a plurality of physical computing devices. The computing device 10 may, in some examples, be instantiated at least in part at one or more client computing devices. The one or more client computing devices may be configured to communicate with the one or more server computing devices over a network.

The processor 12 may be configured to receive an energy function E of a combinatorial optimization problem 20. As discussed above, the energy function E may be expressed as a sum of a plurality of terms Tⱼ that are each products of a corresponding weight ωⱼ and one or more variables Xᵢ. In other examples, the energy function E may include one or more nonlinear terms that depend nonlinearly on one or more of the variables Xᵢ. The processor 12 may be further configured to receive a min/max indicator 22 that indicates whether an estimated minimum or an estimated maximum of the energy function E is configured to be determined when the processor 12 estimates a solution 52 to the combinatorial optimization problem 20.

It will be understood that it is a goal of the processor 12 executing the stochastic algorithms described herein to find an optimal solution, even though it will not always do so. Solutions 52 given by the algorithm are all valid solutions to the combinatorial optimization problem 20, even though they may not be optimal. In other words, the solution 52 is a valid estimation of an optimal solution, even though it may not be an optimal solution.

The processor 12 may be further configured to compute an inverse temperature lower bound βₛₜₐᵣₜ start and an inverse temperature upper bound β_{end} for the combinatorial optimization problem 20. As discussed above, the inverse temperature lower bound βₛₜₐᵣₜ may be a starting inverse temperature value and the inverse temperature upper bound β_{end} may be an inverse temperature ending value used when the processor 12 executes an MCMC algorithm 50.

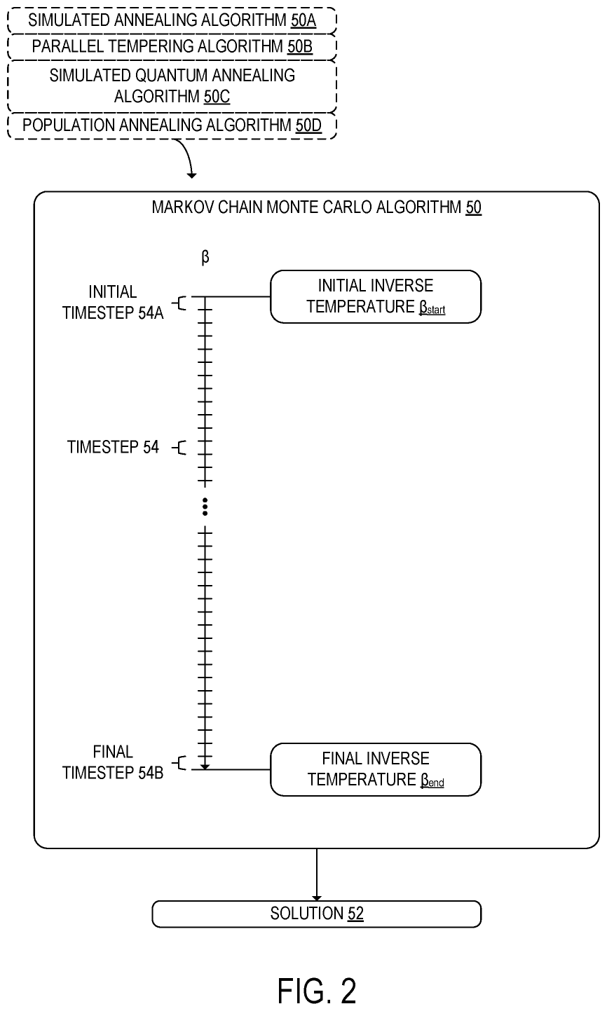

FIG. 2 schematically shows the MCMC algorithm 50, according to one example, when the processor 12 is configured to compute the solution 52 to the combinatorial optimization problem 20 at least in part by executing the MCMC algorithm 50 over a plurality of timesteps 54. In the example of FIG. 2, the inverse temperature β of the MCMC algorithm 50 is set to the inverse temperature lower bound βₛₜₐᵣₜ during an initial timestep 54A of the plurality of timesteps 54, and the inverse temperature of β the MCMC algorithm 50 is set to the inverse temperature upper bound β_{end} during a final timestep 54B of the plurality of timesteps 54. In some examples, the processor 12 may be configured to increase the inverse temperature β linearly over the plurality of timesteps 54. In other examples, the processor 12 may be configured to increase the inverse temperature β according to some other function.

The MCMC algorithm 50 may, for example, be a simulated annealing algorithm 50A, a parallel tempering algorithm 50B, a simulated quantum annealing algorithm 50C, or a population annealing algorithm 50D. In some examples, such as when the MCMC algorithm 50 is a parallel tempering algorithm 50B, the processor 12 may be configured to use multiple different values of the inverse temperature β concurrently when executing the MCMC algorithm 50.

As an alternative to the MCMC techniques listed above, the processor 12 may be configured to execute a stochastic algorithm such as tabu search that is at least partially non-Markovian. In such examples, the probabilities of retaining updates to the variables Xᵢ may be path-dependent at some timesteps 54.

Returning to FIG. 1, the MCMC algorithm 50 may be further configured to receive a maximum acceptance probability P_{high} and a minimum acceptance probability P_{low} that respectively indicate the maximum and minimum probabilities of accepting an update to a variable Xᵢ when that update moves the value of the energy function E further from an optimal value. The maximum acceptance probability P_{high} and the minimum acceptance probability P_{low} may be related to the inverse temperature lower bound βₛₜₐᵣₜ and the inverse temperature upper bound β_{end} by the following start end inequalities:

e^{-β}^{ₛₜₐᵣₜ}^{ΔE}≥P_{high}

e^{-β}^{_{end}}^{ΔE}≤P_{low}

These inequalities may be solved for βₛₜₐᵣₜ and β_{end} to obtain:

$${β}_{start} \leq \frac{- ln ( {P}_{h i g h} )}{Δ E}$$

$${β}_{e n d} \geq \frac{- ln ( {P}_{low} )}{Δ E}$$

The above inequalities for βₛₜₐᵣₜ and β_{end} may be rewritten as equations for βₛₜₐᵣₜ and β_{end} in terms of maximum and minimum changes in the value of the energy function E between successive timesteps 54:

$${β}_{start} = \frac{- ln ( {P}_{h i g h} )}{Δ {E}_{max}}$$

$${β}_{e n d} = \frac{- ln ( {P}_{low} )}{Δ {E}_{min}}$$

In the equation for β_{end}, the minimum change in the energy function ΔEₘᵢₙ is the minimum change in the value of the energy function when the energy function E is updated to a less optimal value (a higher value in a minimization problem or a lower value in a maximization problem).

In the above equations for βₛₜₐᵣₜ and β_{end}, the maximum change in the energy function ΔEₘₐₓ and the minimum change in the energy function ΔEₘᵢₙ are given as follows:

$$Δ {E}_{max} = {max}_{{X}_{i} ∈ V} max \vert Δ {E}_{T ( {X}_{i} )} \vert$$

$$Δ {E}_{min} = {min}_{{X}_{i} ∈ V} min \vert Δ {E}_{T ( {X}_{i} )} \vert$$

However, computing the exact values of ΔEₘₐₓ and ΔEₘᵢₙ is an NP-complete problem. When the combinatorial optimization problem 20 is an Ising problem, the inner maximum in the equation for ΔEₘₐₓ is given by:

max|ΔE_{T(X}_{ᵢ}₎|=max|E_{T(X}_{ᵢ}₌₁₎−E_{T(X}_{ᵢ}₌₋₁₎|=2×max|E_{T(X}_{ᵢ}₌₁₎|

When the combinatorial optimization problem 20 is a PUBO problem, the inner maximum in the equation for ΔEₘₐₓ is given by:

max|ΔE_{T(X}_{ᵢ}₎|=max|E_{T(X}_{ᵢ}₌₁₎−E_{T(X}_{ᵢ}₌₀₎|=max|E_{T(X}_{ᵢ}₌₁₎|

Since computing max|E_{T(X}_{ᵢ}₌₁₎| is another binary optimization problem with one less variable, computing ΔEₘₐₓ is NP-complete for both Ising problems and PUBO problems. Similarly, exact computation of ΔEₘᵢₙ can be proven to be NP-complete by replacing ΔEₘₐₓ with ΔEₘᵢₙ in the above equations.

Since the MCMC algorithm 50 is a stochastic algorithm, using approximate values of βₛₜₐᵣₜ start and β_{end} still allows for efficient estimation of the solution to the combinatorial optimization problem 20. Thus, the processor 12 may be configured to estimate ΔEₘₐₓ and DE mjn rather than computing exact values. Computing the inverse temperature lower bound βₛₜₐᵣₜ may include estimating the maximum change in the energy function ΔEₘₐₓ between successive timesteps 54 of the plurality of timesteps 54. In addition, computing the inverse temperature upper bound β_{end} may include estimating the minimum change in the energy function ΔEₘᵢₙ between successive timesteps 54 of the plurality of timesteps 54. The processor 12 may be configured to execute a maximum energy change estimation algorithm 30 to estimate ΔEₘₐₓ and execute a minimum energy change estimation algorithm 40 to estimate ΔEₘᵢₙ.

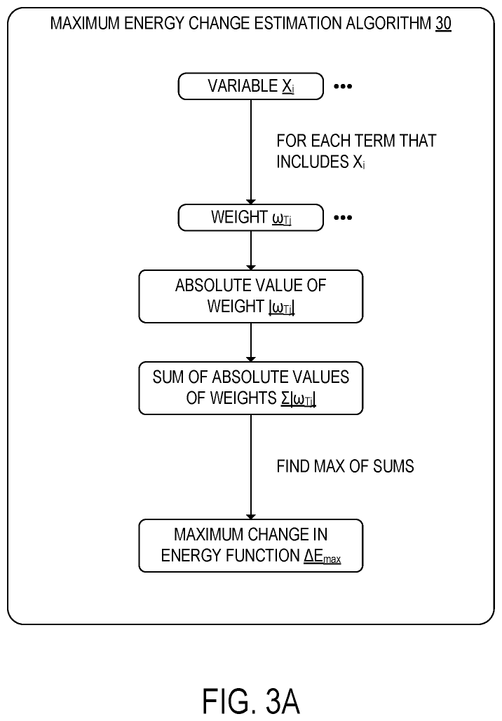

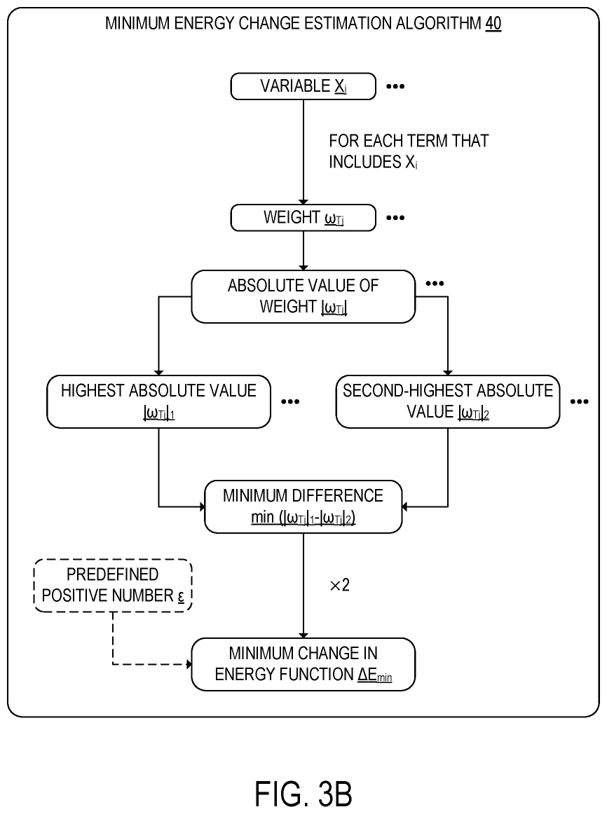

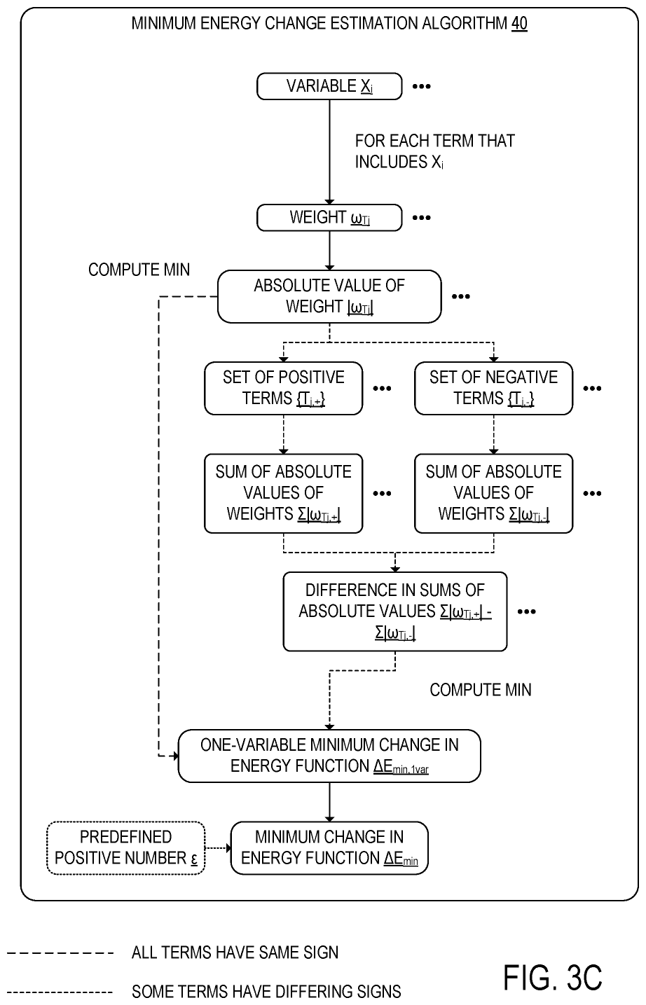

FIG. 3A schematically shows the maximum energy change estimation algorithm 30, according to one example. The processor 12 may be configured to estimate the maximum change in the energy function ΔEₘₐₓ at least in part by computing a maximum amount by which flipping the value of a variable Xᵢ can change the value of the energy function E. For each of the plurality of variables Xᵢ, the processor 12 may be configured to compute a sum of absolute values Σ|ω_{T}_{ⱼ}| of respective weights ω_{T}_{ⱼ} of one or more terms that include that variable Xᵢ. The processor 12 may be further configured to compute the maximum of the sum Σ|ω_{T}_{ⱼ}| over the plurality of variables Xᵢ of the energy function E. The maximum change in the energy function ΔEₘₐₓ may be equal to the maximum of the sum Σ|ω_{T}_{ⱼ}|. The maximum energy change estimation algorithm 30 of FIG. 3A may be used when solving both Ising problems and PUBO problems.

Example pseudocode for the maximum energy change estimation algorithm 30 is provided below:

```
Algorithm MaxDelta(V,T):
delta_max = 0
foreach Xᵢ ϵ V:
      weight_sum = 0
      foreach Tⱼ ϵ T(Xᵢ):
            weight_sum = weight_sum + |ω_{T}_{ⱼ}|
      if weight_sum > delta_max:
            delta_max = weight_sum
return delta_max
```

FIG. 3B schematically shows the minimum energy change estimation algorithm 40 in an example in which the combinatorial optimization problem 20 is an Ising problem. As shown in the example of FIG. 3B, processor 12 may be configured to estimate the minimum change in the energy function ΔEₘᵢₙ at least in part by computing a minimum amount by which flipping the value of a variable Xᵢ can change the value of the energy function E. For each of a plurality of terms Tⱼ that each have a shared variable Xᵢ, the processor 12 may be configured to compute a difference between corresponding highest and second-highest absolute values |ω_{T}_{ⱼ}|₁ and |ω_{T}_{ⱼ}|₂ of respective weights ω_{T}_{ⱼ} of those terms Tⱼ. The processor 12 may be further configured to compute a minimum difference min (|ω_{T}_{ⱼ}|₁−|ω_{T}_{ⱼ}|₂) over a plurality of variables of the energy function E. The minimum change in the energy function ΔEₘᵢₙ may then be computed as two times the minimum difference between the highest and second-highest absolute values.

In some examples, when estimating the minimum change in the energy function ΔEₘᵢₙ, the processor 12 may determine that the estimate of the minimum change in the energy function ΔEₘᵢₙ is equal to zero. In such examples, in response to determining the estimate of the minimum change in the energy function ΔEₘᵢₙ is equal to zero, the processor 12 may be configured to set the estimate of the minimum change in the energy function ΔEₘᵢₙ to a predefined positive number E. For example, the predefined positive number E may be e⁻¹⁰ or some other small positive value. Thus, the processor 12 may be configured to avoid a division by zero when computing β_{end} using ΔEₘᵢₙ.

Example pseudocode for the minimum energy change estimation algorithm 40 when the combinatorial optimization problem is an Ising problem is provided below:

```
Algorithm MinDeltaIsing(V,T):
delta_min = VALUE_MAX
for Xᵢ ϵ V:
      sorted = BalancedBinaryTree( )
      for Tⱼ ϵ T(Xᵢ):
            sorted.add(|ω_{T}_{ⱼ}|)
      while (sorted.size( ) > 1):
            first = sorted.pop( )
            second = sorted.pop( )
            if first == second:
                  sorted.add(first)
            else:
                  sorted.add(first - second)
      local_min = sorted.pop( )
      if (delta_min > local_min):
            delta min = local_min
if (delta_min == 0):
      delta_min = VALUE_POSITIVE_SMALL
return delta_min * 2
```

FIG. 3C schematically shows the minimum energy change estimation algorithm 40 in an example in which the combinatorial optimization problem 20 is a PUBO problem. In the example of FIG. 3C, the processor 12 may be configured to estimate the minimum change in the energy function ΔEₘᵢₙ at least in part by estimating, over the plurality of variables Xᵢ of the energy function E, a minimum of a one-variable minimum change in the energy function ΔE_{min,1var}.

Similarly to when the combinatorial optimization problem 20 is an Ising problem, the processor 12 may also be configured to set the minimum change in the energy function ΔEₘᵢₙ to a predefined positive number ε when the processor 12 determines that the minimum change in the energy function ΔEₘᵢₙ is equal to zero. Setting the minimum change in the energy function ΔEₘᵢₙ to the predefined positive number ε allows the processor 12 to avoid a division by zero when computing β_{end}, as discussed above.

Example pseudocode with which the processor 12 may be configured to estimate the minimum change in the energy function ΔEₘᵢₙ is provided below:

```
Algorithm MinDeltaPUBO(V,T):
delta_min = VALUE_MAX
for Xᵢ ϵ V:
      local_min = OneVariableMinDeltaPUBO(Xᵢ, T(Xᵢ))
      if (delta_min > local_min):
            delta_min = local_min
if (delta_min == 0):
      delta_min = VALUE_POSITIVE_SMALL
return delta_min
```

The minimum energy change estimation algorithm 40 may differ depending on whether all terms of the energy function E have the same sign or whether the energy function E includes a plurality of terms with differing signs. In examples in which all the terms of the energy function E have the same sign, the processor 12 may be configured to estimate the one-variable minimum change in the energy function ΔE_{min,1var} at least in part by computing a minimum of respective absolute values of weights of terms |ω_{T}_{ⱼ}|. This minimum may be computed over terms Tⱼ that include the variable Xᵢ for which the one-variable minimum change in the energy function ΔE_{min,1var} is computed.

In examples in which the energy function E includes a plurality of terms that have differing signs, the processor 12 may be configured to estimate the one-variable minimum change in the energy function ΔE_{min,1var} at least in part by determining a plurality of sets of positive terms {T_{j,+}} and a plurality of sets of negative terms {T_{j,-}} that include the variable Xᵢ for which the one-variable minimum change in the energy function ΔE_{min,1var} is computed. The processor 12 may be further configured to compute corresponding sums of absolute values of respective weights Σ|ω_{T}_{_{j,+}}| and Σ|ω_{T}_{_{j,−}}| of the sets of positive terms {T_{j,+}} and the sets of negative terms {T_{j,-}} that include the variable Xᵢ. The processor 12 may be further configured to compute differences between the sums of absolute values Σ|ω_{T}_{_{j,+}}| and Σ|ω_{T}_{_{j,−}}| and estimate the one-variable minimum change in the energy function ΔE_{min,1var} as the minimum of these differences.

Example pseudocode with which the processor 12 may be configured to estimate the one-variable minimum change in the energy function ΔE_{min,1var} is provided below:

```
Algorithm OneVariableMinDeltaPUBO(Xᵢ, T(Xᵢ)):
local_min = min {|ω_{T}_{ⱼ}|, ∀Tⱼ ϵ T(Xᵢ)}
positives = BalancedBinaryTree( )
negatives = BalancedBinaryTree( )
for Tⱼ ϵ T(Xᵢ):
      if ω_{T}_{ⱼ} > 0:
            positives.add(ω_{T}_{ⱼ})
      else:
            negatives.add(−ω_{T}_{ⱼ})
if positives.size( ) == 0 or negatives.size( ) == 0:
      return local_min
while positives.size( ) > 0 and negatives.size( ) > 0:
      cur_positive = positives.pop( )
      cur_negative = negatives.pop( )
      delta = cur positive - cur_negative
      if delta > 0:
            positives.add(delta)
      else if delta < 0:
            negatives.add(-delta)
            delta = -delta
      else:
            if positives.size( ) > negatives.size( ):
                  negatives.add(cur_negative)
            else:
                  positives.add(cur_positive)
      if local_min > delta and delta != 0:
            local_min = delta
return local_min
```

As discussed above, subsequently to computing the inverse temperature lower bound βₛₜₐᵣₜ and the inverse temperature upper bound β_{end}, the processor 12 may be further configured to compute the solution 52 to the combinatorial optimization problem 20 at least in part by executing the MCMC algorithm 50 over the plurality of timesteps 54. The inverse temperature β may be equal to the inverse temperature lower bound βₛₜₐᵣₜ during the initial timestep 54A and equal to the inverse temperature upper bound β_{end} during the final timestep 54B. The processor 12 may be further configured to output the solution 52 to the combinatorial optimization problem 20. For example, the processor 12 may be configured to output the solution 52 for display at the GUI 60. Additionally or alternatively, the solution 52 may be output to one or more other computing processes.

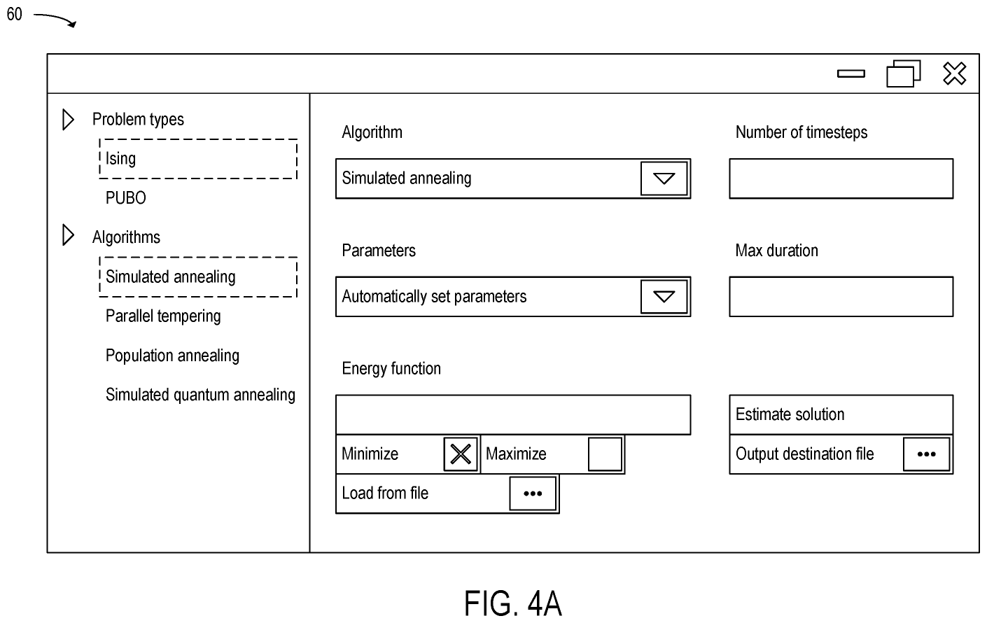

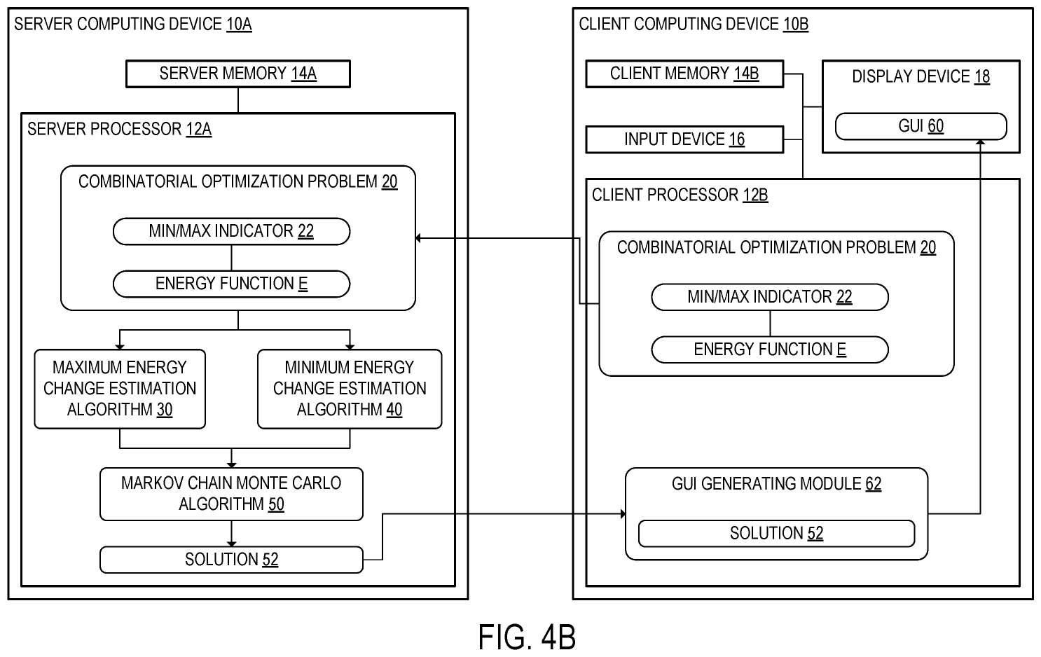

FIG. 4A shows the GUI 60 according to one example. In the example of FIG. 4A, the processor 12 may be configured to receive the energy function E via the GUI 60. The user may also set the min/max indicator 22 at the GUI 60. In this example, the GUI 60 is in an “automatically set parameters” mode. Thus, the processor 12 may be configured to receive the energy function E without receiving the inverse temperature lower bound βₛₜₐᵣₜ or the inverse temperature upper bound β_{end} at the GUI The maximum acceptance probability β_{high} and the minimum acceptance probability β_{low} may be set to default values when the “automatically set parameters” mode is used. Alternatively, the user may specify the values of β_{high} and β_{low} at the GUI 60. When the processor 12 computes the solution 52 to the combinatorial optimization problem 20, the processor 12 may be configured to output the solution 52 to the GUI 60 for display to the user.

FIG. 4B shows a server computing device 10A that is configured to communicate with a client computing device 10B in an example in which the solution 52 is configured to be output for display at the GUI 60. In the example of FIG. 4B, the server computing device 10A includes a server processor 12A and server memory 14A. The client computing device 10B, as shown in the example of FIG. 4B, may include a client processor 12B, client memory 14B, the one or more user input devices 16, and the display device 18 at which the GUI 60 is configured to be displayed. The client processor 12B of the client computing device 10B may be configured to transmit the specification of the combinatorial optimization problem 20 to the server processor 12A of the server computing device 10A. The server processor 12A may be configured to execute the maximum energy change estimation algorithm 30, the minimum energy change estimation algorithm 40, and the Markov chain Monte Carlo algorithm 50 to generate the solution 52. The server processor 12A may be further configured to transmit the solution 52 to the client computing device 10B. The client device processor 12B may be further configured to execute a GUI generating module 62 configured to receive the solution 52. Thus, the client processor 12B may be configured to generate, for display at the display device 18, a view of the GUI 60 that depicts the solution 52.

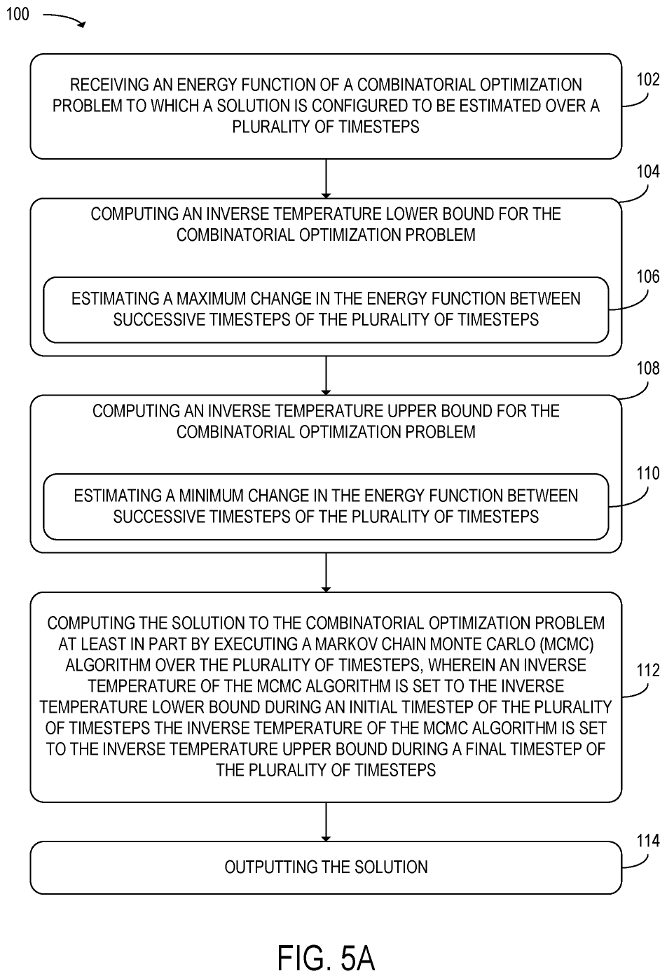

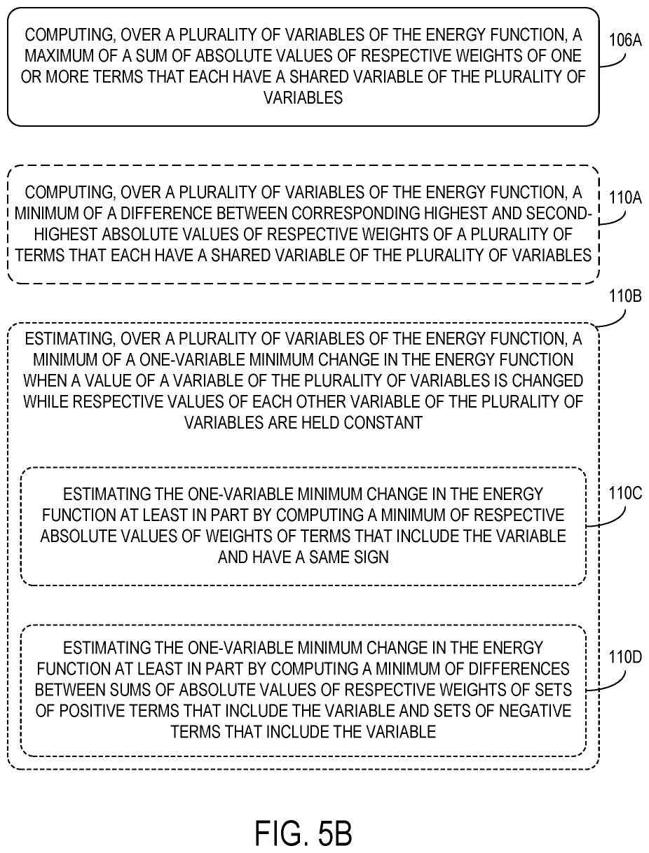

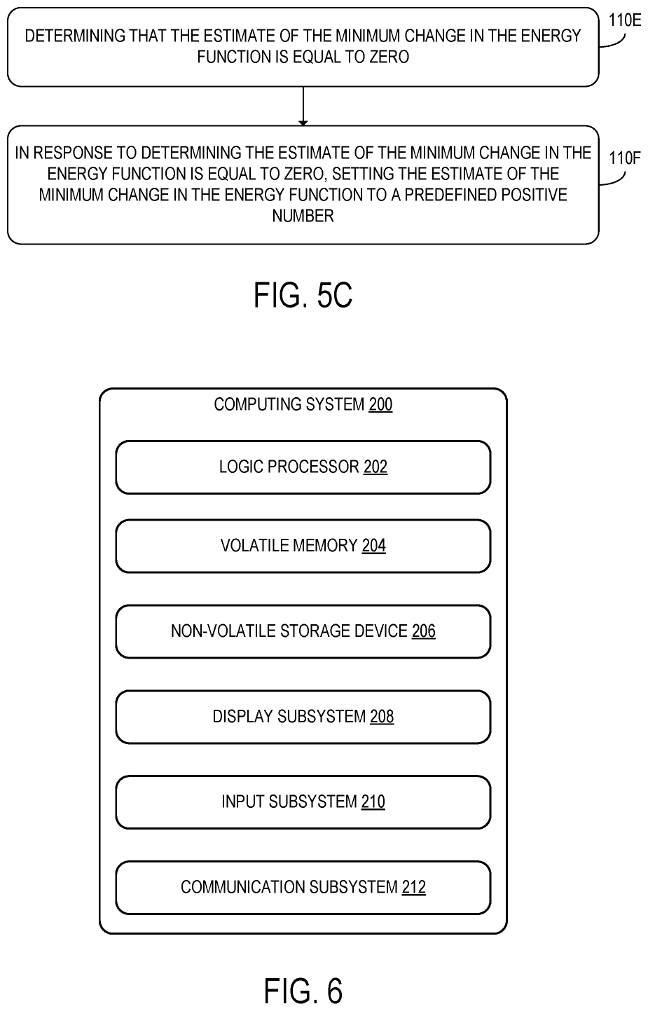

FIG. 5A shows a flowchart of a method 100 for use with a computing device. At step 102, the method 100 may include receiving an energy function of a combinatorial optimization problem to which a solution is configured to be estimated over a plurality of timesteps. The combinatorial optimization problem may be an Ising problem or a PUBO problem. A min/max indicator that indicates whether the combinatorial optimization problem is a minimization problem or a maximization problem may also be received at step 102. In some examples, the energy function may be received via a GUI. In such examples, the energy function may be received without receiving an inverse temperature lower bound or an inverse temperature upper bound at the GUI. The inverse temperature lower bound and the inverse temperature upper bound may instead be computed programmatically as discussed below.

At step 104, the method 100 may further include computing an inverse temperature lower bound for the combinatorial optimization problem. Computing the inverse temperature lower bound at step 104 may include, at step 106, estimating a maximum change in the energy function between successive timesteps of the plurality of timesteps. The inverse temperature lower bound may then be computed from the estimated maximum change in the energy function and from a maximum acceptance probability for transitions to less-optimal values of the energy function.

At step 108, the method 100 may further include computing an inverse temperature upper bound for the combinatorial optimization problem. Computing the inverse temperature upper bound at step 108 may include, at step 110, estimating a minimum change in the energy function between successive timesteps of the plurality of timesteps. The minimum change in the energy function is a minimum change that may occur when the value of the energy function is updated to a less-optimal value. The inverse temperature upper bound may be computed from the estimated minimum change in the energy function and from a minimum acceptance probability for transitions to less-optimal values of the energy function.

At step 112, the method 100 may further include computing the solution to the combinatorial optimization problem at least in part by executing an MCMC algorithm over the plurality of timesteps. For example, the MCMC algorithm may be a simulated annealing algorithm, a parallel tempering algorithm, a simulated quantum annealing algorithm, or a population annealing algorithm. When the MCMC algorithm is executed, an inverse temperature of the MCMC algorithm may be set to the inverse temperature lower bound during an initial timestep of the plurality of timesteps. In addition, the inverse temperature of the MCMC algorithm may be set to the inverse temperature upper bound during a final timestep of the plurality of timesteps. Over the course of executing the MCMC algorithm, the inverse temperature may increase from the inverse temperature lower bound to the inverse temperature upper bound according to a linear function or some other function.

At step 114, the method 100 may further include outputting the solution to the combinatorial optimization problem. In some examples, the solution may be output for display at the GUI. Additionally or alternatively, the solution may be output to one or more other computing processes for further processing.

FIG. 5B shows additional steps of the method 100 that may be performed in some examples when computing the maximum change in the energy function and the minimum change in the energy function. At step 106A, estimating the maximum change in the energy function may include computing, over a plurality of variables of the energy function, a maximum of a sum of absolute values of respective weights of one or more terms. The one or more terms for which the sums of the absolute values of the weights are computed may be terms that each have a shared variable of the plurality of variables. Accordingly, when step 106A is performed, the maximum change in the energy function may be estimated as the maximum change that would occur in the value of the energy function if all the terms that include a specific variable were added or subtracted.

FIG. 5B further shows step 110A, which may be performed when estimating the minimum change in the energy function in examples in which the combinatorial optimization problem is an Ising problem. At step 110A, the method 100 may further include computing, over a plurality of variables of the energy function, a minimum of a difference between corresponding highest and second-highest absolute values of respective weights of a plurality of terms. The terms for which the minimum difference is computed may be terms that each have a shared variable of the plurality of variables. This minimum difference may be multiplied by two to obtain the minimum change in the energy function.

FIG. 5B further shows step 110B, which may be performed when estimating the minimum change in the energy function in examples in which the combinatorial optimization problem is a PUBO problem. At step 110B, the method 100 may further include estimating, over a plurality of variables of the energy function, a minimum of a one-variable minimum change in the energy function when a value of a variable of the plurality of variables is changed while respective values of each other variable of the plurality of variables are held constant. The one-variable minimum change in the energy function may be a minimum amount by which the value of the energy function may change when a change in one variable updates the energy function to a less-optimal value.

Step 110B may include step 110C in examples in which all the terms of the energy function have the same sign and may include step 110D in examples in which the energy function includes a plurality of terms that have differing signs. At step 110C, step 110B may include estimating the one-variable minimum change in the energy function at least in part by computing a minimum of respective absolute values of weights of terms that include the variable and have a same sign. At step 110D, step 110B may instead include estimating the one-variable minimum change in the energy function at least in part by computing a minimum of differences between sums of absolute values of respective weights of sets of positive terms that include the variable and sets of negative terms that include the variable.

FIG. 5C shows additional steps of the method 100 that may be performed in some examples when estimating the minimum change in the energy function at step 110. The steps of FIG. 5C may be performed in examples in which the combinatorial optimization problem is an Ising problem and in examples in which the combinatorial optimization problem is a PUBO problem. At step 110E, the method 100 may further include determining that the estimate of the minimum change in the energy function is equal to zero. At step 110F, the method 100 may further include, in response to determining the estimate of the minimum change in the energy function is equal to zero, setting the estimate of the minimum change in the energy function to a predefined positive number. A division by zero may therefore be avoided when computing the inverse temperature upper bound.

Using the devices and methods discussed above, the inverse temperature values used when solving a combinatorial optimization problem may be computed programmatically without the user having to manually search for suitable values of an inverse temperature lower bound and an inverse temperature upper bound. Thus, the devices and methods discussed above may save the user time when initializing an MCMC solver to estimate a solution to the combinatorial optimization problem. In addition, the devices and methods discussed above may allow the MCMC solver to use values of the inverse temperature lower bound and the inverse temperature upper bound that result in efficient convergence to the solution. Computing the inverse temperature lower bound and the inverse temperature upper bound as discussed above may allow the MCMC solver to quickly and consistently reach values of the solution that accurately approximate the global minimum or maximum of the energy function.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows a non-limiting embodiment of a computing system 200 that can enact one or more of the methods and processes described above. Computing system 200 is shown in simplified form. Computing system 200 may embody the computing device 10 described above and illustrated in FIG. 1. Computing system 200 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 200 includes a logic processor 202 volatile memory 204, and a non-volatile storage device 206. Computing system 200 may optionally include a display subsystem 208, input subsystem 210, communication subsystem 212, and/or other components not shown in FIG. 6.

Logic processor 202 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 202 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Volatile memory 204 may include physical devices that include random access memory. Volatile memory 204 is typically utilized by logic processor 202 to temporarily store information during processing of software instructions. It will be appreciated that volatile memory 204 typically does not continue to store instructions when power is cut to the volatile memory 204.

Non-volatile storage device 206 includes one or more physical devices configured to hold instructions executable by the logic processors to implement the methods and processes described herein. When such methods and processes are implemented, the state of non-volatile storage device 206 may be transformed—e.g., to hold different data.

Non-volatile storage device 206 may include physical devices that are removable and/or built-in. Non-volatile storage device 206 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Aspects of logic processor 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via logic processor 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device, and thus transform the state of the non-volatile storage device, the state of display subsystem 208 may likewise be transformed to visually represent changes in the underlying data. Display subsystem 208 may include one or more display devices utilizing virtually any type of technology. Such display devices may be combined with logic processor 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem may be configured for communication via a wireless telephone network, or a wired or wireless local- or wide-area network, such as a HDMI over Wi-Fi connection. In some embodiments, the communication subsystem may allow computing system 200 to send and/or receive messages to and/or from other devices via a network such as the Internet.

The following paragraphs discuss several aspects of the present disclosure. According to one aspect of the present disclosure, a computing device is provided, including a processor configured to receive an energy function of a combinatorial optimization problem to which a solution is configured to be estimated over a plurality of timesteps. The processor may be further configured to compute an inverse temperature lower bound for the combinatorial optimization problem. Computing the inverse temperature lower bound may include estimating a maximum change in the energy function between successive timesteps of the plurality of timesteps. The processor may be further configured to compute an inverse temperature upper bound for the combinatorial optimization problem. Computing the inverse temperature upper bound may include estimating a minimum change in the energy function between successive timesteps of the plurality of timesteps. The processor may be further configured to compute the solution to the combinatorial optimization problem at least in part by executing a Markov chain Monte Carlo (MCMC) algorithm over the plurality of timesteps. An inverse temperature of the MCMC algorithm may be set to the inverse temperature lower bound during an initial timestep of the plurality of timesteps. The inverse temperature of the MCMC algorithm may be set to the inverse temperature upper bound during a final timestep of the plurality of timesteps. The processor may be further configured to output the solution.

According to this aspect, the processor may be configured to estimate the maximum change in the energy function at least in part by computing, over a plurality of variables of the energy function, a maximum of a sum of absolute values of respective weights of one or more terms that each have a shared variable of the plurality of variables.

According to this aspect, the combinatorial optimization problem may be an Ising problem.

According to this aspect, the processor may be configured to estimate the minimum change in the energy function at least in part by computing, over a plurality of variables of the energy function, a minimum of a difference between corresponding highest and second-highest absolute values of respective weights of a plurality of terms that each have a shared variable of the plurality of variables.

According to this aspect, the combinatorial optimization problem may be a polynomial unconstrained binary optimization (PUBO) problem.

According to this aspect, the processor may be configured to estimate the minimum change in the energy function at least in part by estimating, over a plurality of variables of the energy function, a minimum of a one-variable minimum change in the energy function when a value of a variable of the plurality of variables is changed while respective values of each other variable of the plurality of variables are held constant.

According to this aspect, the processor may be configured to estimate the one-variable minimum change in the energy function at least in part by computing a minimum of respective absolute values of weights of terms that include the variable and have a same sign.

According to this aspect, the processor may be configured to estimate the one-variable minimum change in the energy function at least in part by computing a minimum of differences between sums of absolute values of respective weights of sets of positive terms that include the variable and sets of negative terms that include the variable.

According to this aspect, the MCMC algorithm may be a simulated annealing algorithm, a parallel tempering algorithm, a simulated quantum annealing algorithm, or a population annealing algorithm.

According to this aspect, the processor may be configured to estimate the minimum change in the energy function at least in part by determining that the estimate of the minimum change in the energy function is equal to zero. Estimating the minimum change in the energy function may further include, in response to determining the estimate of the minimum change in the energy function is equal to zero, setting the estimate of the minimum change in the energy function to a predefined positive number.

According to this aspect, the processor may be configured to receive the energy function via a graphical user interface (GUI) without receiving the inverse temperature lower bound or the inverse temperature upper bound at the GUI. The processor may be further configured to output the solution to the GUI.

According to another aspect of the present disclosure, a method for use with a computing device is provided. The method may include receiving an energy function of a combinatorial optimization problem to which a solution is configured to be estimated over a plurality of timesteps. The method may further include computing an inverse temperature lower bound for the combinatorial optimization problem. Computing the inverse temperature lower bound may include estimating a maximum change in the energy function between successive timesteps of the plurality of timesteps. The method may further include computing an inverse temperature upper bound for the combinatorial optimization problem. Computing the inverse temperature upper bound may include estimating a minimum change in the energy function between successive timesteps of the plurality of timesteps. The method may further include computing the solution to the combinatorial optimization problem at least in part by executing a Markov chain Monte Carlo (MCMC) algorithm over the plurality of timesteps. An inverse temperature of the MCMC algorithm may be set to the inverse temperature lower bound during an initial timestep of the plurality of timesteps. The inverse temperature of the MCMC algorithm may be set to the inverse temperature upper bound during a final timestep of the plurality of timesteps. The method may further include outputting the solution.

According to this aspect, computing the maximum change in the energy function may include computing, over a plurality of variables of the energy function, a maximum of a sum of absolute values of respective weights of one or more terms that each have a shared variable of the plurality of variables.

According to this aspect, the combinatorial optimization problem may be an Ising problem.

According to this aspect, estimating the minimum change in the energy function may include computing, over a plurality of variables of the energy function, a minimum of a difference between corresponding highest and second-highest absolute values of respective weights of a plurality of terms that each have a shared variable of the plurality of variables.

According to this aspect, the combinatorial optimization problem may be a polynomial unconstrained binary optimization (PUBO) problem.

According to this aspect, estimating the minimum change in the energy function may include estimating, over a plurality of variables of the energy function, a minimum of a one-variable minimum change in the energy function when a value of a variable of the plurality of variables is changed while respective values of each other variable of the plurality of variables are held constant.

According to this aspect, the MCMC algorithm may be a simulated annealing algorithm, a parallel tempering algorithm, a simulated quantum annealing algorithm, or a population annealing algorithm.

According to this aspect, estimating the minimum change in the energy function may include determining that the estimate of the minimum change in the energy function is equal to zero. Estimating the minimum change in the energy function may further include, in response to determining the estimate of the minimum change in the energy function is equal to zero, setting the estimate of the minimum change in the energy function to a predefined positive number.

According to another aspect of the present disclosure, a computing device is provided, including a processor configured to receive an energy function of a combinatorial optimization problem to which a solution is configured to be estimated over a plurality of timesteps. The processor may be further configured to compute an inverse temperature lower bound for the combinatorial optimization problem. Computing the inverse temperature lower bound may include estimating a maximum change in the energy function between successive timesteps of the plurality of timesteps. The maximum change in the energy function may be estimated at least in part by computing, over a plurality of variables of the energy function, a maximum of a sum of absolute values of respective weights of one or more terms that each have a shared variable of the plurality of variables. The processor may be further configured to compute an inverse temperature upper bound for the combinatorial optimization problem. Computing the inverse temperature upper bound may include estimating a minimum change in the energy function between successive timesteps of the plurality of timesteps. The minimum change in the energy function may be estimated at least in part by estimating, over the plurality of variables of the energy function, a minimum of a difference between corresponding highest and second-highest absolute values of respective weights of a plurality of terms that each have a shared variable of the plurality of variables, or a one-variable minimum change in the energy function when a value of a variable of the plurality of variables is changed while respective values of each other variable of the plurality of variables are held constant. The processor may be further configured to compute the solution to the combinatorial optimization problem at least in part by executing a Markov chain Monte Carlo (MCMC) algorithm over the plurality of timesteps. An inverse temperature of the MCMC algorithm may be set to the inverse temperature lower bound during an initial timestep of the plurality of timesteps. The inverse temperature of the MCMC algorithm may be set to the inverse temperature upper bound during a final timestep of the plurality of timesteps. The processor may be further configured to output the solution.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device comprising:
a processor configured to:
receive an energy function of a combinatorial optimization problem to which a solution is configured to be estimated over a plurality of timesteps;
compute an inverse temperature lower bound for the combinatorial optimization problem, wherein computing the inverse temperature lower bound includes estimating a maximum change in the energy function between successive timesteps of the plurality of timesteps;
compute an inverse temperature upper bound for the combinatorial optimization problem, wherein computing the inverse temperature upper bound includes estimating a minimum change in the energy function between successive timesteps of the plurality of timesteps;
compute the solution to the combinatorial optimization problem at least in part by executing a Markov chain Monte Carlo (MCMC) algorithm over the plurality of timesteps, wherein:
an inverse temperature of the MCMC algorithm is set to the inverse temperature lower bound during an initial timestep of the plurality of timesteps; and
the inverse temperature of the MCMC algorithm is set to the inverse temperature upper bound during a final timestep of the plurality of timesteps; and
output the solution.

2. The computing device of claim 1, wherein the processor is configured to estimate the maximum change in the energy function at least in part by computing, over a plurality of variables of the energy function, a maximum of:
a sum of absolute values of respective weights of one or more terms that each have a shared variable of the plurality of variables.

3. The computing device of claim 1, wherein the combinatorial optimization problem is an Ising problem.

4. The computing device of claim 3, wherein the processor is configured to estimate the minimum change in the energy function at least in part by computing, over a plurality of variables of the energy function, a minimum of:
a difference between corresponding highest and second-highest absolute values of respective weights of a plurality of terms that each have a shared variable of the plurality of variables.

5. The computing device of claim 1, wherein the combinatorial optimization problem is a polynomial unconstrained binary optimization (PUBO) problem.

6. The computing device of claim 5, wherein the processor is configured to estimate the minimum change in the energy function at least in part by estimating, over a plurality of variables of the energy function, a minimum of:
a one-variable minimum change in the energy function when a value of a variable of the plurality of variables is changed while respective values of each other variable of the plurality of variables are held constant.

7. The computing device of claim 6, wherein the processor is configured to estimate the one-variable minimum change in the energy function at least in part by computing a minimum of:
respective absolute values of weights of terms that include the variable and have a same sign.

8. The computing device of claim 6, wherein the processor is configured to estimate the one-variable minimum change in the energy function at least in part by computing a minimum of:
differences between sums of absolute values of respective weights of:
sets of positive terms that include the variable; and
sets of negative terms that include the variable.

9. The computing device of claim 1, wherein the MCMC algorithm is a simulated annealing algorithm, a parallel tempering algorithm, a simulated quantum annealing algorithm, or a population annealing algorithm.

10. The computing device of claim 1, wherein the processor is configured to estimate the minimum change in the energy function at least in part by:
determining that the estimate of the minimum change in the energy function is equal to zero; and
in response to determining the estimate of the minimum change in the energy function is equal to zero, setting the estimate of the minimum change in the energy function to a predefined positive number.

11. The computing device of claim 1, wherein the processor is configured to:
receive the energy function via a graphical user interface (GUI) without receiving the inverse temperature lower bound or the inverse temperature upper bound at the GUI; and
output the solution to the GUI.

12. A method for use with a computing device, the method comprising:
receiving an energy function of a combinatorial optimization problem to which a solution is configured to be estimated over a plurality of timesteps;
computing an inverse temperature lower bound for the combinatorial optimization problem, wherein computing the inverse temperature lower bound includes estimating a maximum change in the energy function between successive timesteps of the plurality of timesteps;
computing an inverse temperature upper bound for the combinatorial optimization problem, wherein computing the inverse temperature upper bound includes estimating a minimum change in the energy function between successive timesteps of the plurality of timesteps;
computing the solution to the combinatorial optimization problem at least in part by executing a Markov chain Monte Carlo (MCMC) algorithm over the plurality of timesteps, wherein:
an inverse temperature of the MCMC algorithm is set to the inverse temperature lower bound during an initial timestep of the plurality of timesteps; and
the inverse temperature of the MCMC algorithm is set to the inverse temperature upper bound during a final timestep of the plurality of timesteps; and
outputting the solution.

13. The method of claim 12, wherein computing the maximum change in the energy function includes computing, over a plurality of variables of the energy function, a maximum of:
a sum of absolute values of respective weights of one or more terms that each have a shared variable of the plurality of variables.

14. The method of claim 12, wherein the combinatorial optimization problem is an Ising problem.

15. The method of claim 14, wherein estimating the minimum change in the energy function includes computing, over a plurality of variables of the energy function, a minimum of:
a difference between corresponding highest and second-highest absolute values of respective weights of a plurality of terms that each have a shared variable of the plurality of variables.

16. The method of claim 12, wherein the combinatorial optimization problem is a polynomial unconstrained binary optimization (PUBO) problem.

17. The method of claim 16, estimating the minimum change in the energy function includes estimating, over a plurality of variables of the energy function, a minimum of:
a one-variable minimum change in the energy function when a value of a variable of the plurality of variables is changed while respective values of each other variable of the plurality of variables are held constant.

18. The method of claim 12, wherein the MCMC algorithm is a simulated annealing algorithm, a parallel tempering algorithm, a simulated quantum annealing algorithm, or a population annealing algorithm.

19. The method of claim 12, wherein estimating the minimum change in the energy function includes:
determining that the estimate of the minimum change in the energy function is equal to zero; and
in response to determining the estimate of the minimum change in the energy function is equal to zero, setting the estimate of the minimum change in the energy function to a predefined positive number.

20. A computing device comprising:
a processor configured to:
receive an energy function of a combinatorial optimization problem to which a solution is configured to be estimated over a plurality of timesteps;
compute an inverse temperature lower bound for the combinatorial optimization problem, wherein computing the inverse temperature lower bound includes estimating a maximum change in the energy function between successive timesteps of the plurality of timesteps at least in part by computing, over a plurality of variables of the energy function, a maximum of:
a sum of absolute values of respective weights of one or more terms that each have a shared variable of the plurality of variables;
compute an inverse temperature upper bound for the combinatorial optimization problem, wherein computing the inverse temperature upper bound includes estimating a minimum change in the energy function between successive timesteps of the plurality of timesteps at least in part by estimating, over the plurality of variables of the energy function, a minimum of:
a difference between corresponding highest and second-highest absolute values of respective weights of a plurality of terms that each have a shared variable of the plurality of variables; or
a one-variable minimum change in the energy function when a value of a variable of the plurality of variables is changed while respective values of each other variable of the plurality of variables are held constant;
compute the solution to the combinatorial optimization problem at least in part by executing a Markov chain Monte Carlo (MCMC) algorithm over the plurality of timesteps, wherein:
an inverse temperature of the MCMC algorithm is set to the inverse temperature lower bound during an initial timestep of the plurality of timesteps; and
the inverse temperature of the MCMC algorithm is set to the inverse temperature upper bound during a final timestep of the plurality of timesteps; and
output the solution.
